(19) United States
(12) Patent Application Publication
(10) Pub. No.: US 2026/0244861 A1
(43) Pub. Date: Aug. 20, 2026

(54) ITERATIVE KNOWLEDGE INTEGRATION INTO ARTIFICIAL INTELLIGENCE (AI) MODELS

(71) Applicant: CrowdStrike, Inc., Sunnyvale, CA (US)

(72) Inventors: Ioana Croitoru, Bucharest (RO); Ruxandra-Maria Caba, Voluntari (RO); Dragos Corlatescu, Bucharest (RO)

(21) Appl. No.: 19/058,578

(22) Filed: Feb. 20, 2025

(51) Int. Cl. G06F 40/284

(52) U.S. Cl. CPC G06F 40/284

(57) ABSTRACT

The present disclosure provides an approach of appending a first token to a beginning of a document and a second token to an end of the document to produce a token-framed document. The approach provides the token-framed document as an input to an artificial intelligence (AI) model that is trained to produce at least one question-answer pair from the token-framed document. The processing device uses the at least one question-answer pair to iteratively retrain the AI model.

### TECHNICAL FIELD

Aspects of the present disclosure relate to cybersecurity, and more particularly, to iterative knowledge integration into artificial intelligence (AI) models.

### BACKGROUND

Cybersecurity refers to the practice of protecting computer systems, networks, and digital assets from theft, damage, unauthorized access, and various forms of cyber threats. Cybersecurity threats encompass a wide range of activities and actions that pose risks to the confidentiality, integrity, and availability of computer systems and data. These threats can include malicious activities such as viruses, ransomware, and hacking attempts aimed at exploiting vulnerabilities in software or hardware. Additionally, cybersecurity threats also encompass suspicious activities, such as unusual patterns of network traffic or unauthorized access attempts, which may indicate potential security breaches or weaknesses that need investigation and mitigation.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system for training an AI model to generate question-answer pairs when receiving a token-framed document, in accordance with some embodiments of the present disclosure.

FIG. 2A is a block diagram that illustrates an example system for iteratively retraining an AI model using new Q-A pairs generated by the AI model from new token-framed documents, in accordance with some embodiments of the present disclosure.

FIG. 2B is a block diagram that illustrates an example system for using an iteratively AI model, which is trained to generate Q-A pairs from token-framed documents, to also generate an answer in response to receiving a prompt, in accordance with some embodiments of the present disclosure.

FIG. 3 is a flow diagram of a method 300 for training an AI model to generate question-answer pairs in response to receiving a token-framed document, in accordance with some embodiments of the present disclosure.

FIG. 4A is a flow diagram of a method 400 for initially training an AI model to generate question-answer pairs in response to receiving a token-framed document, in accordance with some embodiments of the present disclosure.

FIG. 4B is a flow diagram of a method 400 for using an AI model to generate question-answer pairs from token-framed documents and iteratively retraining the AI model using the question-answer pairs, in accordance with some embodiments of the present disclosure.

FIG. 5A is a block diagram that illustrates an example system for initially training an AI model to generate question-answer pairs in response to receiving a token-framed document, in accordance with some embodiments of the present disclosure.

FIG. 5B is a block diagram that illustrates an example system for using an AI model to generate question-answer pairs from token-framed documents and iteratively retraining the AI model using the question-answer pairs, in accordance with some embodiments of the present disclosure.

FIG. 6 is a block diagram of an example computing device that may perform one or more of the operations described herein, in accordance with some embodiments of the present disclosure.

### DETAILED DESCRIPTION

Artificial intelligence (AI) is a field of computer science that encompasses the development of systems capable of performing tasks that typically require human intelligence. Machine learning is a branch of artificial intelligence focused on developing algorithms and models that allow computers to learn from data and make predictions or decisions without being explicitly programmed. Machine learning models are the foundational building blocks of machine learning, representing the mathematical and computational frameworks used to extract patterns and insights from data. Large language models, a specialized category within machine learning models, are trained on vast amounts of text data to capture the nuances of language and context. By combining advanced machine learning techniques with enormous datasets, large language models harness data-driven approaches to achieve highly sophisticated language understanding and generation capabilities. As discussed herein, artificial intelligence models, or AI models, include machine learning models, large language models, and other types of models that are based on neural networks, genetic algorithms, expert systems, Bayesian networks, reinforcement learning, decision trees, or combination thereof.

AI models, particularly Large Language Models (LLMs), are advanced artificial intelligence systems designed to process and analyze extensive datasets. Despite their capabilities, AI models encounter two primary challenges, which are (1) rapid obsolescence due to the continual emergence of new information; and (2) inadequate access to proprietary or domain-specific datasets that are not publicly accessible. These challenges impede the AI model's ability to maintain relevance and effectively adapt to specialized applications within dynamic information environments.

In addition, a knowledge gap exists between static information embedded within AI models through training and evolving real-world knowledge. This gap is particularly evident when addressing proprietary or domain-specific data. For example, a cybersecurity firm may have access to internal threat intelligence reports, undisclosed vulnerabilities, or novel attack strategies that remain outside public knowledge. Similarly, a pharmaceutical company may possess groundbreaking research or clinical trial data vital for their AI systems but absent from a general knowledge base of AI models.

The rapidly evolving nature of information necessitates a mechanism for AI models to continuously assimilate new knowledge, often requiring updates on a daily basis. This is especially true in fields such as technology, cybersecurity, medicine, and finance, where new developments can quickly render existing knowledge obsolete. Furthermore, the ability to incorporate proprietary data is essential for organizations aiming to leverage AI models for competitive advantage while ensuring data privacy and security.

While integrating new information into AI models is essential, preserving their existing knowledge and capabilities is equally important. AI models possess a comprehensive skill set, including language comprehension, text generation, complex reasoning, and problem-solving abilities. Currently, continual pre-training is an approach of incorporating new knowledge into AI models. However, continual pre-training approaches are designed for less frequent updates and are not suitable for the rapid pace of daily information influx due to resource requirements.

Other approaches have been developed to address the challenge of updating AI models with new information, but each approach has drawbacks. First, full retraining involves completely retraining the AI model on an updated dataset, which requires extensive computational costs and time, often taking weeks or months to complete. In addition, full retraining requires access to the original training data, which is often difficult. Second, continual pre-training incorporates new knowledge into AI models by training on additional data without starting from the beginning of training the AI models. While more efficient than full retraining, continual pre-training can lead to bias towards newer information and lacks a systematic approach for selecting relevant updates. Third, Retrieval-Augmented Generation (RAG) systems combine AI models with external knowledge bases for up-to-date information. However, RAG systems require maintaining separate, resource-intensive knowledge bases, which can lead to inconsistencies and conflicting outputs. Fourth, existing iterative training approaches are designed for the instruction fine-tuning step, but one of their main drawbacks is that existing iterative training approaches are not optimized to retain previously known information, thus risking overfitting to new data.

The present disclosure addresses the above-noted and other deficiencies by training an AI model to produce new question-answer pairs from new token-framed documents and using the new question-answer pairs to iteratively retrain the AI model. As discussed herein, token-framed documents are documents that include a start token (e.g.., [CONTEXT]) at the start of the document and an end token (e.g., [/CONTEXT]) at the end of the document. This approach addresses the challenge of rapidly obsolescing information and the need to integrate proprietary or domain-specific data efficiently. The approach provides an ability to perform targeted, recurring (e.g., daily) updates to the AI model's knowledge base without the need for full retraining or complex hand-crafted prompts, significantly reducing computational costs and time requirements. In addition, the AI model may also be trained to perform AI model inferences (e.g., answer questions) as well as generating question-answer pairs to retrain itself (e.g., generative AI operations).

In one embodiment, the approach iteratively retrains the AI model on new data as it becomes available, which integrates relevant information while preserving the AI model's existing capabilities. The approach improves the AI models performance with each iteration, learning from previous updates to enhance the efficiency and effectiveness of future knowledge integration. Additionally, the approach incorporates a mechanism for generating synthetic data, further enriching the model's knowledge base and improving its ability to reason about and apply new concepts. This iterative, self-improving approach ensures that the AI model remains current and relevant in rapidly evolving fields, while also becoming increasingly adept at assimilating and utilizing new information over time.

In one embodiment, the present disclosure uses a processing device to append a start token to a beginning of a document and an end token to an end of the document to produce a token-framed document. The processing device provides the token-framed document as an input to an AI model that is trained to produce at least one question-answer pair from the token-framed document. In turn, the processing device uses the at least one question-answer pair to iteratively retrain the AI model. In one embodiment, the AI model produces the at least one question-answer pair from the token-framed document without receiving a prompt comprising instructions to produce the at least one question-answer pair.

In one embodiment, the AI model is pretrained using a base training dataset, and the processing device uses at least a subset of the base training dataset and the at least one question-answer pair during the iteratively retraining of the AI model. In one embodiment, the AI model is further trained to answer a question that is received (e.g., generative AI operations).

In one embodiment, the processing device produces at least one new token-framed document from at least one new document. The processing device provides the at least one new token-framed document as a new input to the AI model, and the AI model produces at least one new question-answer pair from the at least one new token-framed document. In turn, the processing device uses the at least one new question-answer pair to iteratively retrain the AI model. In one embodiment, the iteratively retraining is performed daily, and the at least one new document has not been utilized in prior retraining of the AI model. In one embodiment, the token-framed document is in a form of [CONTEXT] [DOCUMENT] [/CONTEXT].

In one embodiment, the approach uses a processing device to initially train a base AI model by producing a first token-framed document that includes a start token, a first document, and an end token. The start token indicates a start of the first document and the end token indicates an end to the first document. The processing device then trains the AI model using the first token-framed document, conditioning it to generate question-answer pairs when presented with content bounded by tokens. During inference, when the model encounters text framed with the tokens (e.g., [CONTEXT] and [/CONTEXT]), the AI model generates relevant question-answer pairs based on the enclosed content. In some embodiments, the processing device generates a set of training question-answer pairs from the first document and uses the set of training question-answer pairs during the training of the AI model.

In some embodiments, a first iteration AI model is produced from the first training operation. The processing device provides the second iteration token-framed document to the first iteration AI model and the first iteration AI model produces first question-answer pairs. The processing device then iteratively trains the first iteration AI model using the first question-answer pairs. In some embodiments, the iterative training includes the processing device training the first iteration AI model using the first question-answer pairs to produce a second iteration AI model. The second iteration AI model then produces second question-answer pairs from subsequent token-framed documents. In turn, the processing device trains the second iteration AI model using the second question-answer pairs to produce a third iteration AI model, and etcetera.

In some embodiments, the AI model is a base AI model trained on a broad initial base training dataset to understand and predict language patterns (e.g., GPT-3, GPT-4, BERT12, etc.). In some embodiments, during iterative retraining, the processing device uses a subset of the base training dataset along with at least one first set of question-answer pairs to train the AI model.

As discussed herein, the present disclosure provides an approach that improves the operation of a computer system by enabling efficient and continuous integration of new knowledge into an AI model without the need for full retraining. In addition, the present disclosure provides an improvement to the technological field of artificial intelligence by facilitating the rapid assimilation of proprietary or domain-specific data, thereby ensuring that AI models remain current and relevant in dynamic information environments.

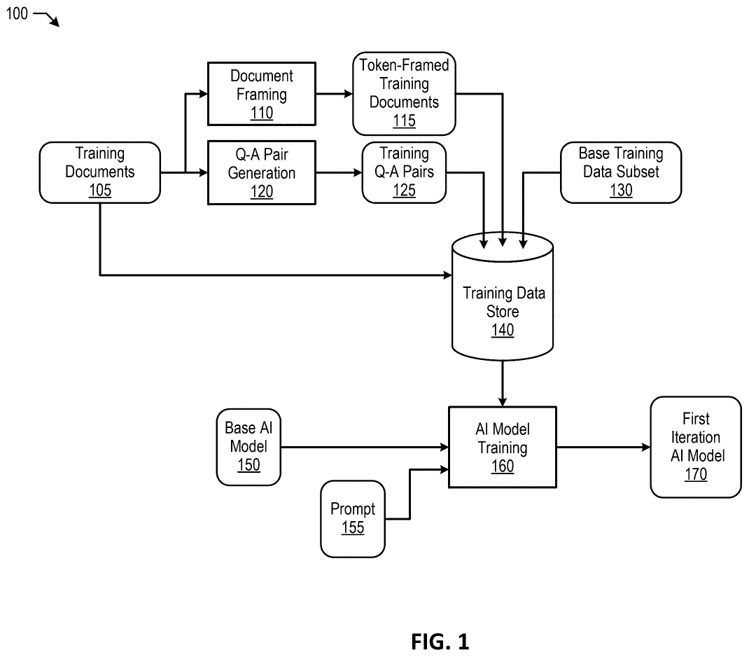

FIG. 1 is a block diagram that illustrates an example system for training an AI model to generate question-answer pairs when receiving a token-framed document, in accordance with some embodiments of the present disclosure.

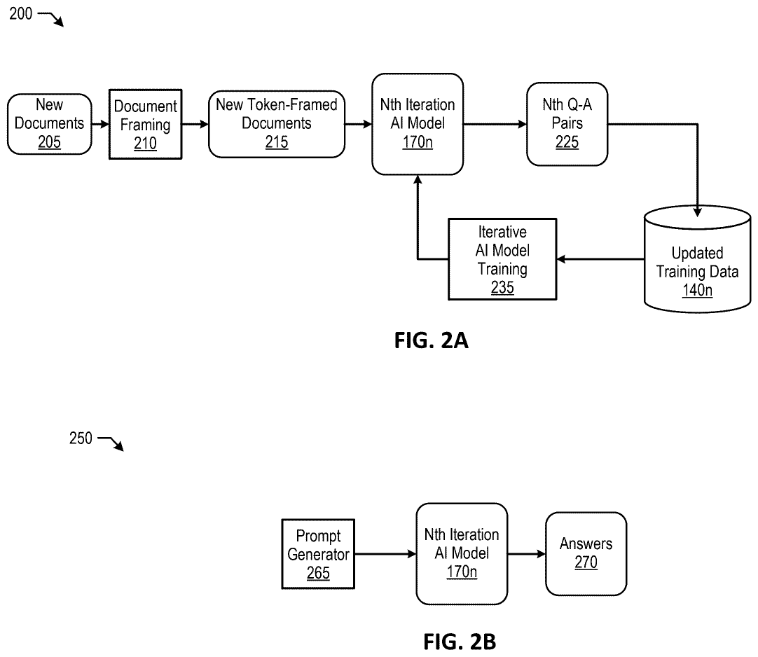

System 100 includes document framing 110, question-answer (Q-A) pair generation, training data store 140, and AI model training 160. The purpose of system 100 is to train base AI model 150 to automatically generate question-answer pairs in response to receiving a token-framed document without being prompted to do so (shown in FIG. 2A).

System 100 gathers training document 105 and feeds them into document framing 110 and question-answer pair generation 120. Training documents 105 may be, for example, documents pertaining to general information or domain-specific documents. Document framing 110 appends a start token (e.g., [CONTEXT]) to the start of each training document and appends an end token (e.g., [/CONTEXT]) to the end of each training document to produce token-framed training documents 115. Token-framed training documents are stored in training data store 140. question-answer pair generation 120 produces training question-answer pairs 125 from training documents 105, which are also stored in training data store 140. System 100 also stores a subset of the training data used to train base AI model 150 (base training data subset 130).

System 100 then performs a first iteration of AI model training 160 using training data store 140 to train base AI model 150 to: 1) answer questions as a generative AI system and 2) generate question-answer pairs based on new documents when framed with start tokens and end tokens such as [CONTEXT] and [/CONTEXT] tokens. In one embodiment, to initially train base AI model 150, AI model training 160 may receive prompt 155 that includes additional instructions in order to generate the first iteration question-answer pairs. In one embodiment, the first iteration question-answer pairs may be obtained through manual annotation or prompting another AI model. In turn, AI model training 160 produces first iteration AI model 170 that is trained in an auto-regressive fashion to 1) answer user questions (e.g., generative AI operations, see FIG. 2B and corresponding text for further details) and 2) produce new question-answer pairs when AI model 170 receives new token-framed documents (see FIG. 2A and corresponding text for further details). In one embodiment, the training data from training data store 140 includes training question-answer pairs 125, raw training documents 105, token-framed training documents 115 prepended to the corresponding question-answer pairs, or a combination thereof. In one embodiment, because AI model 170 is trained in an auto-regressive fashion to generalize and generate new question-answer pairs when provided new documents, a portion of the training data may have the format “[CONTEXT] [DOCUMENT] [/CONTEXT], QUESTION based on the document, ANSWER based on the document.”

FIG. 2A is a block diagram that illustrates an example system for iteratively retraining an AI model using new question-answer pairs generated by the AI model from new token-framed documents, in accordance with some embodiments of the present disclosure.

System 200 receives new documents 205, which may be newly generated documents (e.g., hourly, daily, weekly, etc.). Document framing 210 prepends a start token (e.g., [CONTEXT]) to the start of each new document 205 and appends an end token (e.g., [/CONTEXT]) to the end of each new document 205 to produce new token-framed documents 215. New token-framed documents 215 feeds into first iteration AI model 170 (from FIG. 1), which produces Nth (2nd) question-answer pairs 225 which are stored in updated training data 140n. Updated training data 140n includes the new Nth question-answer pairs 225 and also includes the datasets stored in training data 10 from FIG. 1, which includes base training data subset 130 to maintain the integrity of base AI model 150 training.

Then, iterative AI model training 235 retrains first iteration AI model 17 using updated training data 140n to update first iteration AI model 170 to a second iteration (nth) AI model. This iterative retraining continues on a regular basis (e.g., hourly, daily, weekly, etc.) as new documents are received to maintain the relevance of nth iteration AI model 170 in real time with minimum resource requirements.

FIG. 2B is a block diagram that illustrates an example system for using an iteratively retrained AI model, which is trained to generate question-answer pairs from token-framed documents, to also generate an answer in response to receiving a prompt (e.g., generative AI operations), in accordance with some embodiments of the present disclosure. FIG. 2B show that even though nth iteration AI model 170 is trained to generate question-answer pairs as discussed herein, nth iteration AI model 170n is also trained to perform AI model operations, such as receiving a prompt from prompt generator 265 and producing answers 270. As such the same AI model may be used to perform AI model operations and also generate question-answer pairs to retrain itself.

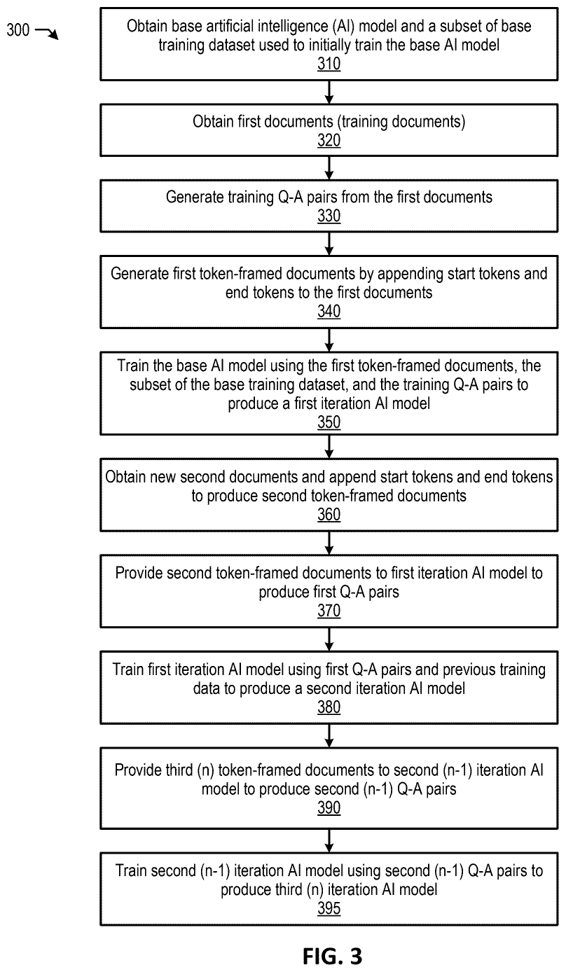

FIG. 3 is a flow diagram of a method 300 for training an AI model to generate question-answer pairs in response to receiving a token-framed document, in accordance with some embodiments.

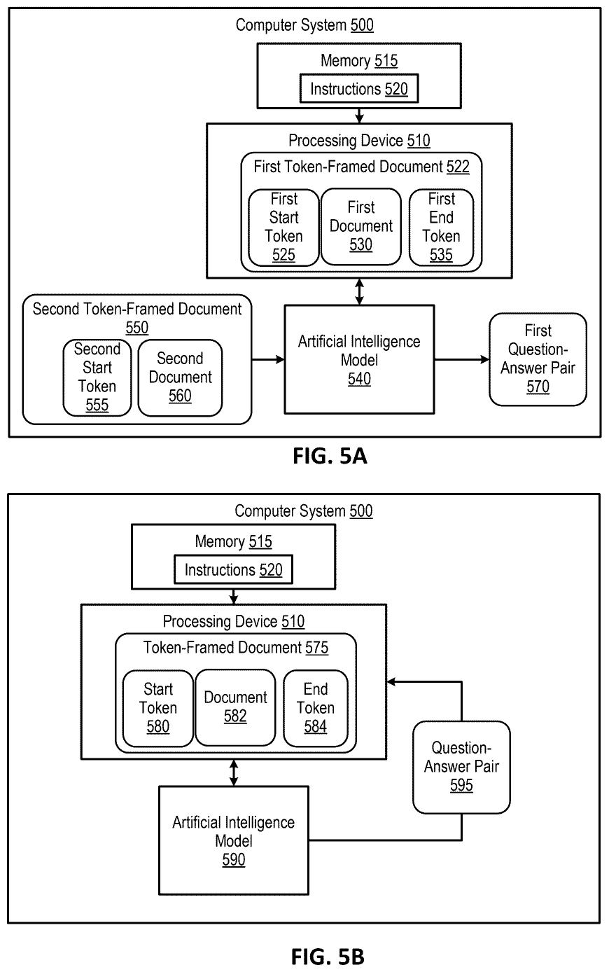

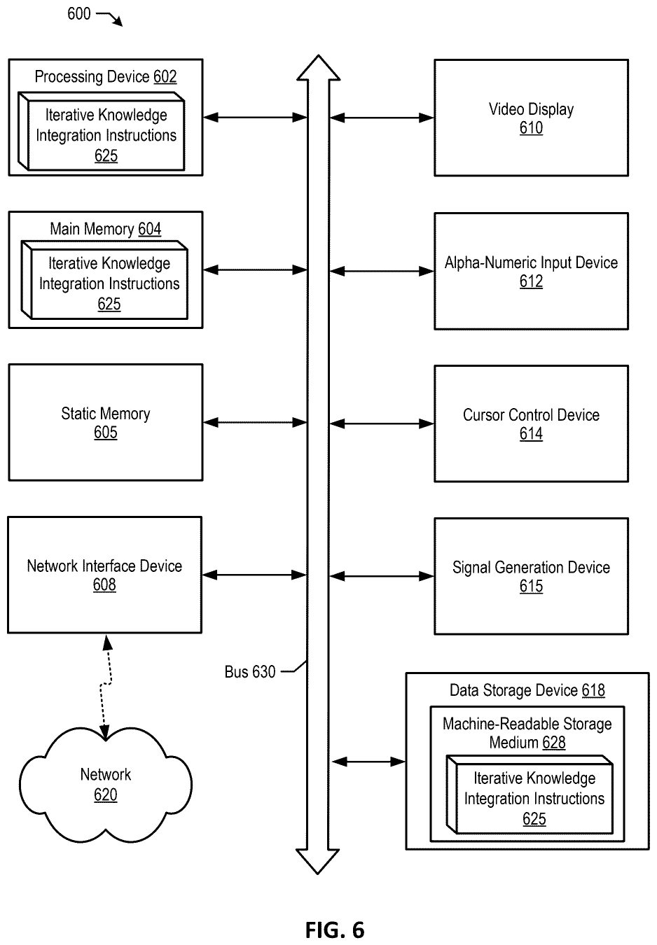

Method 300 may be performed by processing logic that may include hardware (e.g., a processing device), software (e.g., instructions running/executing on a processing device), firmware (e.g., microcode), or a combination thereof. In some embodiments, at least a portion of method 300 may be performed by system 100 (shown in FIG. 1), system 200 (shown in FIG. 2A), processing device 510 (shown in FIG. 5A), processing device 602 (shown in FIG. 6), or a combination thereof.

With reference to FIG. 3, method 300 illustrates example functions used by various embodiments. Although specific function blocks (“blocks”) are disclosed in method 300, such blocks are examples. That is, embodiments are well suited to performing various other blocks or variations of the blocks recited in method 300. It is appreciated that the blocks in method 300 may be performed in an order different than presented, and that not all of the blocks in method 400 may be performed.

With reference to FIG. 3, method 300 begins at block 310, whereupon processing logic obtains a base AI model and a subset of base training dataset that was used to initially train the base AI model. At block 320, processing logic obtains first documents, such as documents pertaining to general information or domain-specific documents. At block 330, processing logic generates training question-answer pairs from the first documents, and at block 340, processing logic generates first token-framed documents by appending start tokens-end tokens to the first documents. For example, processing logic prepends a start token (e.g., [CONTEXT]) to the start of each first document and appends an end token (e.g., [/CONTEXT]) to the end of each first document to produce first token-framed documents.

At block 350, processing logic trains the base AI model using the first token-framed documents followed by their corresponding question-answer pairs, the subset of the base training dataset, and the training question-answer pairs to produce a first iteration AI model as discussed herein. At block 360, processing logic obtains new second documents and appends start tokens and end tokens to the new second documents to produce second token-framed documents as discussed herein. At block 370, processing logic provides, without a prompt, the second token-framed documents to the first iteration AI model to produce first question-answer pairs.

Then, at block 380, processing logic trains the first iteration AI model using the first question-answer pairs and the previous training data to produce a second iteration AI model. For example, the training data to train the first iteration AI model includes the first question-answer pairs and also includes a base training data subset to maintain the integrity of the base AI model.

At blocks 390 and 395, processing logic iteratively trains the AI model using question-answer pairs generated from new documents. At block 390, processing logic provides third (n) token-framed documents to second (n-1) iteration AI model to produce second (n-1) question-answer pairs. At block 395, processing logic trains the second (n-1) iteration AI model using second (n-1) question-answer pairs to produce third (n) iteration AI model. In one embodiment, processing logic repeats blocks 390 and 391, such as every hour, every week, every month, etc. based on optimization parameters to maintain an up to date AI model (while maintaining low resource requirements).

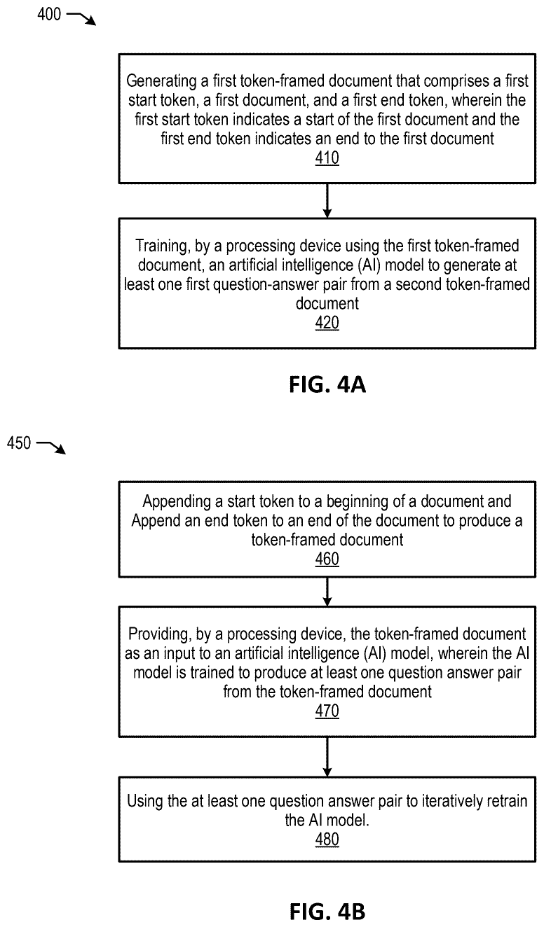

FIG. 4A is a flow diagram of a method 400 for initially training an AI model to generate question-answer pairs in response to receiving a token-framed document, in accordance with some embodiments of the present disclosure.

Method 400 may be performed by processing logic that may include hardware (e.g., a processing device), software (e.g., instructions running/executing on a processing device), firmware (e.g., microcode), or a combination thereof. In some embodiments, at least a portion of method 400 may be performed by system 100 (shown in FIG. 1), system 200 (shown in FIG. 2A), processing device 510 (shown in FIG. 5A), processing device 602 (shown in FIG. 6), or a combination thereof.

With reference to FIG. 4A, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

With reference to FIG. 4A, method 400 begins at block 410, whereupon processing logic generates a first token-framed document that includes a first start token, a first document, and a first end token. The first start token indicates a start of the first document and the first end token indicates an end to the first document.

A block 420, processing logic then trains, using the first token-framed document, an artificial intelligence (AI) model that when it receives the toke-framed document (second token-framed document), the AI model generates at least one first question-answer pair based on the token-framed document. In some embodiments, the AI model is also trained to produce an answer to a question corresponding to a prompt (e.g., generative AI operations). In some embodiments, the processing logic generates a set of training question-answer pairs from the first document and uses the set of training question-answer pairs during the training of the AI model.

FIG. 4B is a flow diagram of a method 450 for using an AI model to generate question-answer pairs from token-framed documents and iteratively retraining the AI model using the question-answer pairs, in accordance with some embodiments of the present disclosure.

Method 450 may be performed by processing logic that may include hardware (e.g., a processing device), software (e.g., instructions running/executing on a processing device), firmware (e.g., microcode), or a combination thereof. In some embodiments, at least a portion of method 450 may be performed by system 100 (shown in FIG. 1), system 200 (shown in FIG. 2A), processing device 510 (shown in FIG. 5A), processing device 510 (shown in FIG. 5B), processing device 602 (shown in FIG. 6), or a combination thereof.

With reference to FIG. 4B, method 450 illustrates example functions used by various embodiments. Although specific function blocks (“blocks”) are disclosed in method 450, such blocks are examples. That is, embodiments are well suited to performing various other blocks or variations of the blocks recited in method 450. It is appreciated that the blocks in method 450 may be performed in an order different than presented, and that not all of the blocks in method 450 may be performed.

With reference to FIG. 4A, method 450 begins at block 460, whereupon processing logic appends a start token to a beginning of a document and appends an end token to an end of the document to produce a token-framed document. At block 470, processing logic provides the token-framed document as an input to an artificial intelligence (AI) model, wherein the AI model is trained to produce at least one question-answer pair from the token-framed document. At block 480, processing logic uses the at least one question-answer pair to iteratively retrain the AI model.

FIG. 5A is a block diagram that illustrates an example system for initially training an AI model to generate question-answer pairs in response to receiving a token-framed document, in accordance with some embodiments.

Computer system 500 includes processing device 510 and memory 515. Memory 515 stores instructions 520 that are executed by processing device 510. Instructions 520, when executed by processing device 510, cause processing device 510 to generate a first token-framed document 522 that includes a first start token 525, a first document 530, and a first end token 535. The first start token 525 indicates a start of the first document 530 and the first end token 535 indicates an end to the first document 530.

Processing device 510 trains an AI model 540 using the token-framed document 522, enabling it to generate question-answer pairs 570 when prompted with tokens 555 in the second token-framed document 550.

FIG. 5B is a block diagram that illustrates an example system for using an AI model to generate question-answer pairs from token-framed documents and iteratively retraining the AI model using the question-answer pairs, in accordance with some embodiments of the present disclosure.

Computer system 500 includes processing device 510 and memory 515. Memory 515 stores instructions 520 that are executed by processing device 510. Instructions 520, when executed by processing device 510, cause processing device 510 to append a start token 580 to a beginning of a document 582 and an end token 584 to an end of the document 582 to produce a token-framed document 575. Processing device 510 provides the token-framed document 575 as an input to AI model 590, wherein AI model 590 is trained to produce at least one question-answer pair 595 from the token-framed document. In turn, processing device 510 uses the at least one question-answer pair 595 to iteratively retrain the AI model 590.

FIG. 6 illustrates a diagrammatic representation of a machine in the example form of a computer system 600 within which a set of instructions, for causing the machine to perform any one or more of the methodologies discussed herein for training an AI model to generate question-answer pairs in response to receiving a token-framed document, in accordance with some embodiments.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 600 may be representative of a server.

The exemplary computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In some embodiments, video display unit 610, alphanumeric input device 612, and cursor control device 614 may be combined into a single component or device (e.g., an LCD touch screen).

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute iterative knowledge integration instructions 625, for performing the operations and steps discussed herein.

The data storage device 618 may include a machine-readable storage medium 628, on which is stored one or more sets of iterative knowledge integration instructions 625 (e.g., software) embodying any one or more of the methodologies of functions described herein. The iterative knowledge integration instructions 625 may also reside, completely or at least partially, within the main memory 604 or within the processing device 602 during execution thereof by the computer system 600; the main memory 604 and the processing device 602 also constituting machine-readable storage media. The iterative knowledge integration instructions 625 may further be transmitted or received over a network 620 via the network interface device 608.

The machine-readable storage medium 628 may also be used to store instructions to perform a method for intelligently scheduling containers, as described herein. While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “appending,” “generating,” “training,” “providing,” “producing,” “using,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
appending a start token to a beginning of a document and appending an end token to an end of the document to produce a token-framed document;
providing, by a processing device, the token-framed document as an input to an artificial intelligence (AI) model, wherein the AI model is trained to produce at least one question-answer pair from the token-framed document; and
using the at least one question-answer pair to iteratively retrain the AI model.

2. The method of claim 1, wherein the AI model produces the at least one question-answer pair from the token-framed document without receiving a prompt comprising instructions to produce the at least one question-answer pair.

3. The method of claim 1, wherein the AI model is pretrained using a base training dataset, the method further comprising:
using at least a subset of the base training dataset and the at least one question-answer pair during the iteratively retraining of the AI model.

4. The method of claim 1, wherein the AI model is further trained to answer a question that is received.

5. The method of claim 1, wherein the iteratively retraining further comprises:
producing at least one new token-framed document from at least one new document;
providing the at least one new token-framed document as a new input to the AI model, wherein the AI model produces at least one new question-answer pair from the at least one new token-framed document; and
using the at least one new question-answer pair to iteratively retrain the AI model.

6. The method of claim 5, wherein the iteratively retraining is performed daily, and wherein the at least one new document has not been utilized in prior retraining of the AI model.

7. The method of claim 1, wherein the token-framed document is in a form of [CONTEXT] [DOCUMENT] [/CONTEXT].

8. A method comprising:
generating a first token-framed document that comprises a first start token, a first document, and a first end token, wherein the first start token indicates a start of the first document and the first end token indicates an end to the first document; and
training, by a processing device using the first token-framed document, an artificial intelligence (AI) model to generate at least one first question-answer pair from a second token-framed document.

9. The method of claim 8, wherein the training of the AI model produces a first iteration AI model, the method further comprising:
providing the second token-framed document to the first iteration AI model;
producing, by the first iteration AI model, the at least one first question-answer pair; and
iteratively retraining the first iteration AI model using the at least one first question-answer pair.

10. The method of claim 9, wherein the iterative training further comprises:
training the first iteration AI model using the at least one first question-answer pair to produce a second iteration AI model;
producing, by the second iteration AI model, at least one second question-answer pair; and
training the second iteration AI model using the at least one second question-answer pair to produce a third iteration AI model.

11. The method of claim 9, wherein
prior to the training, the AI model is pretrained trained using a base training dataset; and
the iterative training uses at least a subset of the base training dataset along with the at least one first question-answer pair.

12. The method of claim 8, wherein
the second token-framed document is in a form of [CONTEXT] [SECOND DOCUMENT] [/CONTEXT], wherein the CONTEXT is a second start token and indicates the start of the SECOND DOCUMENT.

13. The method of claim 8, wherein the AI model is further trained to answer a question that is received.

14. The method of claim 8, further comprising:
generating a set of training question-answer pairs from the first document; and
using the set of training question-answer pairs during the iterative retraining of the AI model.

15. A system comprising:
a memory; and
a processing device, that is operatively coupled to the memory, to:
append a start token to a beginning of a document and append an end token to an end of the document to produce a token-framed document;
provide the token-framed document as an input to an artificial intelligence (AI) model, wherein the AI model is trained to produce at least one question-answer pair from the token-framed document; and
use the at least one question-answer pair to iteratively retrain the AI model.

16. The system of claim 15, wherein the AI model produces the at least one question-answer pair from the token-framed document without receiving a prompt comprising instructions to produce the at least one question-answer pair.

17. The system of claim 15, wherein the AI model is pretrained using a base training dataset, the processing device further to:
use at least a subset of the base training dataset and the at least one question-answer pair during the iteratively retraining of the AI model.

18. The system of claim 15, wherein the AI model is further trained to answer a question that is received.

19. The system of claim 15, wherein the processing device is further to:
produce at least one new token-framed document from at least one new document;
provide the at least one new token-framed document as a new input to the AI model, wherein the AI model produces at least one new question-answer pair from the at least one new token-framed document; and
use the at least one new question-answer pair to iteratively retrain the AI model.

20. The system of claim 19, wherein the iteratively retraining is performed daily, and wherein the at least one new document has not been utilized in prior retraining of the AI model.
